(19) United States
(12) Patent Application Publication
(10) Pub. No.: US 2026/0330144 A1
(43) Pub. Date: Oct. 22, 2026

(54) PROMPT DEBUGGING USING ATTRIBUTION SCORING

(71) Applicant: International Business Machines Corporation, Armonk, NY (US)

(72) Inventors: Vijay Arya, Gurgaon (IN); Diptikalyan Saha, BANGALORE (IN); Yogish Sabharwal, Gurgaon (IN)

(73) Assignee: International Business Machines Corporation, Armonk, NY (US)

(21) Appl. No.: 19/185,434

(22) Filed: Apr. 22, 2025

(51) Int. Cl. G06F 40/35; G06F 11/3668; G06F 40/51

(52) U.S. Cl. CPC G06F 40/35; G06F 11/3684; G06F 11/3688; G06F 40/51

(57) ABSTRACT

An embodiment extracts a set of prompt features from a user prompt input into a large language model, the set of prompt features comprising a set of context examples. The embodiment constructs a set of test prompts using the set of context examples. The embodiment executes the set of test prompts by the large language model, the executing producing a set of execution results. The embodiment computes an attribution score for each context example, wherein each attribution score reflects a marginal contribution of a corresponding context example. The embodiment manipulates the user prompt by replacing a portion of the user prompt to include a candidate set of context examples, the candidate set of context examples comprising a subset of the context examples identified as providing a greatest combined performance metric based on the set of attribution scores. The embodiment submits the modified prompt input to the large language model.

### BACKGROUND

The present invention relates generally to artificial intelligence. More particularly, the present invention relates to a method, system, and computer program for debugging prompts in generative models.

Artificial intelligence (AI) technology has evolved significantly over the past few years. Modern AI systems are achieving human level performance on cognitive tasks like converting speech to text, recognizing objects and images, or translating between different languages. This evolution holds promise for new and improved applications in many industries.

An Artificial Neural Network (ANN)—also referred to simply as a neural network—is a computing system made up of a number of simple, highly interconnected processing elements (nodes), which process information by their dynamic state response to external inputs. ANNs are processing devices (algorithms and/or hardware) that are loosely modeled after the neuronal structure of the mammalian cerebral cortex but on much smaller scales. A large ANN might have hundreds or thousands of processor units, whereas a mammalian brain has billions of neurons with a corresponding increase in magnitude of their overall interaction and emergent behavior.

A Large Language Model (LLM) is a type of machine learning model designed for natural language processing tasks. An LLM may be trained on immense amounts of data, enabling the LLM to be capable of understanding and generating natural language and other types of content to perform a wide range of tasks. LLMs today may have the ability to infer from context, generate coherent and contextually relevant responses, translate between different languages, summarize text, answer questions, respond to queries, and even assist in creative writing or code generation tasks.

An artificial intelligence (AI) agent refers to a system or program that is capable of autonomously performing tasks on behalf of a user or another system by designing its workflow and utilizing available tools. AI agents can encompass a wide range of functionalities beyond natural language processing including decision-making, problem-solving, interacting with external environments, and executing actions. These agents can be deployed in various applications to solve complex tasks in various contexts from software design and IT automation to code-generation tools and conversational assistants. AI agents often leverage large language models (LLMs) to comprehend and respond to user inputs step-by-step and determine when to call on external tools. AI agents are sometimes referred to as LLM agents if they incorporate an LLM in their functioning.

Shapley explanations are a method used in machine learning to attribute the contribution of individual features or elements to a model's predictions. The Shapley value concept originates from cooperative game theory and provides a fair way to distribute the value generated by a coalition of players among the players based on their marginal contributions. In the context of machine learning, Shapley explanations quantify the importance or impact of each feature on the model's predictions. These explanations offer insights into how much each feature influences the model's decision-making process and output. By calculating Shapley values for each feature, users can understand the relative significance of different features in driving the model's predictions.

Shapley explanations are calculated by considering all possible permutations of features and evaluating the marginal contribution of each feature to the model's predictions. The calculation involves comparing the model's prediction with and without the inclusion of a specific feature to determine the difference in the output. This process is repeated for all possible combinations of features, and the Shapley value for each feature is computed based on its average marginal contribution across all permutations. The Shapley value calculation ensures that each feature is assigned a fair attribution score that reflects its unique contribution to the model's predictions. By considering the interactions and dependencies between features, Shapley explanations provide a comprehensive and interpretable way to understand the importance of individual features in the model's decision-making process.

### SUMMARY

The illustrative embodiments provide a process for prompt debugging using attribution scoring. An embodiment includes intercepting a user input prompt input sent to a large language model. The embodiment also includes extracting a set of prompt features from the user prompt input, the set of prompt features comprising a set of context examples. The embodiment also includes constructing a set of test prompts using the set of context examples, wherein each test prompt of the set of test prompts comprises a different combination of context examples. The embodiment also includes executing the set of test prompts by the large language model, the executing producing a set of execution results. The embodiment also includes causing, responsive to executing the set of test prompts, an execution of a first specific instruction to execute an attribution scoring algorithm to compute an attribution score for each context example, the executing the attribution scoring algorithm producing a set of attribution scores, wherein each attribution score reflects a marginal contribution of a corresponding context example in producing the set of execution results. The embodiment also includes causing, responsive to producing the set of attribution scores, an execution of a second specific instruction to manipulate the user input prompt, the manipulating comprising replacing a portion of the user input prompt to include a candidate set of context examples, the candidate set of context examples comprising a subset of the context examples identified as providing a greatest combined performance metric based on the set of attribution scores, the manipulating producing a modified prompt input. The embodiment also includes causing, responsive to producing the modified prompt input, an execution of a fourth specific instruction that submits the modified prompt input to the large language model.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment;

FIG. 2 depicts a block diagram of an example computing environment in accordance with an illustrative embodiment;

FIG. 3 depicts a block diagram of an example software module in accordance with an illustrative embodiment;

FIG. 4 depicts a block diagram of an example prompting process in accordance with an illustrative embodiment;

FIG. 5 depicts a block diagram of an example prompt debugging process in accordance with an illustrative embodiment; and

FIG. 6 depicts a flowchart of an example process for prompt debugging using attribution scores in accordance with an illustrative embodiment.

### DETAILED DESCRIPTION

Prompting refers to the process of providing a specific input, typically in the form of text, to guide the generation of an output by a large language model (LLM). The prompt serves as a starting point and context for the model to generate coherent and relevant output based on the provided input. The prompt influences the content, style, and structure of the generated output by conditioning the LLM's generation process.

The prompting mechanism of an LLM includes several components that work together to guide the generation of text by the LLM. The prompt serves as the initial input that influences the content generated by the model. The prompt may include a few words, a sentence, a paragraph, a code snippet, an image, or any other digital media that provides the context or theme for the generated output. The prompt may be further concatenated with an input sequence. The input sequence includes the prompt and any additional context or information that the model uses to generate an output. By combining the prompt with the input sequence, the model can generate an output that is relevant to the given prompt. The model produces an output based on the prompt and input sequence, taking into account the language patterns and context learned during training. The output reflects the influence of the prompt on the generated content.

Large language models (LLMs) are currently used in a variety of generative applications, including but not limited to, code translation, code generation, code summarization, and so on. In many such applications, LLMs are used along with in-context prompt examples to guide the model to perform a specific task more accurately. The process typically involves providing the LLM with relevant prompt examples that are directly related to the task at hand. These in-context prompt examples offer specific cues, instructions, or information that help steer the model's text generation towards the desired outcome. By incorporating task-specific examples, the LLM gains relevant context and guidance to produce more precise and relevant outputs.

The utilization of in-context prompt examples enables the model to focus its attention on the particular task requirements, leading to improved performance and accuracy. These in-context examples serve as reference points for the LLM, influencing the model's generation process to align with the task objectives and/or constraints. Accordingly, by leveraging in-context prompt examples, the behavior of an LLM may be configured and tailored to suit the specific task demands, leading to enhanced performance and task completion. This approach enhances the model's ability to generate outputs that are coherent, relevant, and aligned with the desired task outcomes.

However, despite improvement in LLMs and prompt-engineering techniques, LLMs are nevertheless known only to work well with few in-context examples. Additionally, LLMs typically can only accommodate a limited context length. Therefore, the number of such in-context examples are typically limited. Further, in situations where end-users get unexpected outcomes, the reasoning for the unexpected outcomes may be unclear, and the steps of a debugging process to ultimately guide the LLM to provide the expected outcome are also unknown to the end-user. Accordingly, in situations where end-users get unexpected outcomes, it may be unclear to the user how the user may be able to debug the prompt. For example, a user may be unaware of which example pair to modify or update to generate a better or more desirable outcome. Accordingly, users often may have chosen wrong or less than optimal examples or even unintentionally introduced errors into the example pairs.

The present disclosure addresses the deficiencies described above by providing a process (as well as a system, method, machine-readable medium, etc.) that develops an attribution score based debugging system. Embodiments of the present disclosure provide a method to compute local model-agnostic Shapley explanations that provide per example attribution scores for each prediction. Embodiments of the present disclosure are compatible with any LLM architecture, encoder-decoder combinations, and so forth.

Embodiments of the present disclosure consider the following usage in manual prompt engineering: Attribution scores could be used to debug prompts and help prompt engineers and agents to iteratively design better LLM prompts during manual prompt engineering.

Embodiments of the present disclosure consider the following usage in dynamic prompt engineering: Attribution scores can provide feedback to RAG (retrieval augmented generation) systems to measure the quality of retrieved in-context examples.

As used throughout the present disclosure, the term “Shapley explanation” refers to a method that quantifies the contribution of each feature to the prediction outcome of a machine learning model. Shapley explanations provide insights into the importance and impact of individual features on model predictions by assigning attribution scores that reflect the influence of each feature in the prediction process.

As used throughout the present disclosure, the term “attribution score” refers to value assigned to each feature in a machine learning model to quantify the contribution of that feature to the model's prediction for a specific data point. Attribution scores provide a measure of the importance or influence of individual features on the model's decision-making process, offering insights into the relative impact of each feature on the final prediction outcome.

As used throughout the present disclosure, the term “importance weights” refers to values assigned to features in a machine learning model to indicate the relative significance or contribution of each feature towards the model's predictions. These weights reflect the importance of individual features in influencing the model's decision-making process, with higher weights indicating greater importance and influence on the model's output.

As used throughout the present disclosure, the term “in-context example” refers to a specific instance or sample provided to a machine learning model that is directly relevant to the task or context at hand. These examples are tailored to the specific requirements of the model's current task, providing relevant cues, information, or context to guide the model's decision-making process. In-context examples serve as targeted inputs that help the model focus on the task-specific features or patterns necessary to improve performance and accuracy in generating outputs aligned with the desired task objectives.

For example, in the context of guiding a model on how to transform between Python code and Java code, in-context examples can be structured as example pairs consisting of Python code snippets and corresponding Java code snippets. These example pairs serve as targeted guidance for the model, providing specific cues and information on the transformation process between the two programming languages.

By incorporating example pairs of Python code snippets and Java code snippets within the in-context examples, the model receives direct instructions on how to convert or transform code from one language to another. Each pair may represent a specific transformation scenario, illustrating the corresponding logic, syntax, and structure between Python and Java code. The Python code snippets in the example pairs demonstrate the functionality or logic in Python, while the corresponding Java code snippets showcase the equivalent implementation in Java. These pairs guide the model on understanding the language-specific differences and similarities, aiding in the accurate translation of code between Python and Java. The model learns from the patterns and mappings between Python and Java code demonstrated in the example pairs, enabling the model to generate accurate and contextually relevant transformations between the two languages.

As another example, in the context of text summarization, the example-pair may include an original text paragraph and a corresponding summarized text paragraph. This example-pair may aid the model in generating concise summaries of longer text passages by providing examples of original text and their corresponding summaries.

As another example, in the context of image captioning, the example-pair may include an image and a caption. This example-pair may aid the model in generating descriptive captions for images by presenting pairs of images and their associated captions as in-context examples.

As another example, in the context of document classification, the example-pair may include document text and a category label. This example-pair may aid the model in categorizing documents by presenting pairs of document text and their assigned category labels as examples for document classification tasks.

As another example, in the context of sentiment analysis, the example-pair may include a text review and a sentiment label (positive/negative). This example-pair may aid the model in classifying sentiment in text data by providing pairs of text reviews and their sentiment labels as examples for sentiment analysis tasks.

As another example, in the context of machine translation, the example-pair may include source language text and target language translation. This example-pair may aid the model in translating text between different languages by offering pairs of source language text and their corresponding translations as in-context examples.

As another example, in the context of question answering, the example-pair may include a question and an answer. This example-pair may aid the model in answering questions by providing pairs of questions and their corresponding answers to train the model for question-answering tasks.

As another example, in the context of named entity recognition, the example-pair may include a text sentence and identified named entities. This example-pair may aid the model in recognizing and classifying named entities in text data by presenting pairs of sentences and their annotated named entities as examples.

As another example, in the context of speech recognition, the example-pair may include an audio clip and transcribed text. This example-pair may aid the model in transcribing speech to text by providing pairs of audio clips and their corresponding transcribed text as in-context examples.

Although some example use-cases have been described above, embodiments of the present disclosure may extend to many more use-cases that might not be explicitly specifically mentioned in the present disclosure. Embodiments of the present disclosure may extend to any LLM based task and may be adapted to derive attribution scores and construct optimal prompts based on the attribution scores for any example-pairs, or any other artefacts that may be part of a prompt, including but not limited to, instructions, constraints, features, elements, and so forth.

Illustrative embodiments provide for a process for prompt debugging leveraging attribution scores for individual prompt features. An embodiment includes prompting a large language model with a set of prompt features. An embodiment includes computing an attribution score for each prompt feature of the set of prompt features. An embodiment includes generating a prompting recommendation based on the attribution score for each prompt feature of the set of prompt features. An embodiment includes prompting the large language model using the prompting recommendation.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

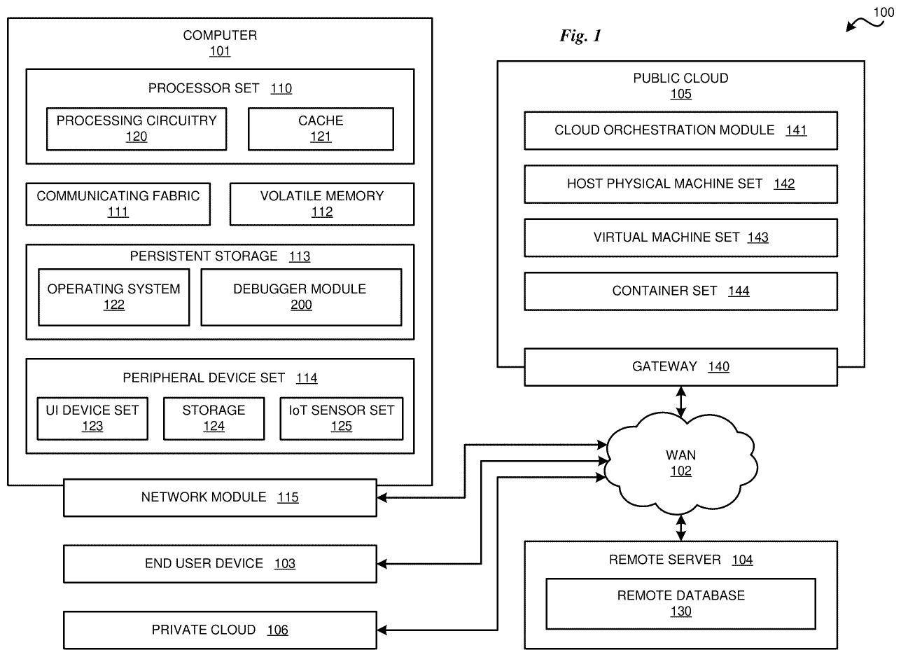

FIG. 1 depicts a block diagram of a computing environment 100. Computing environment 100 contains an example of an environment for the execution of at least some of the computer code involved in performing the inventive methods, such as debugger module 200 that provides prompting recommendations based on desired user outcomes. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, volatile memory 112 is located in a single package and is internal to computer 101, but, alternatively or additionally, volatile memory 112 may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

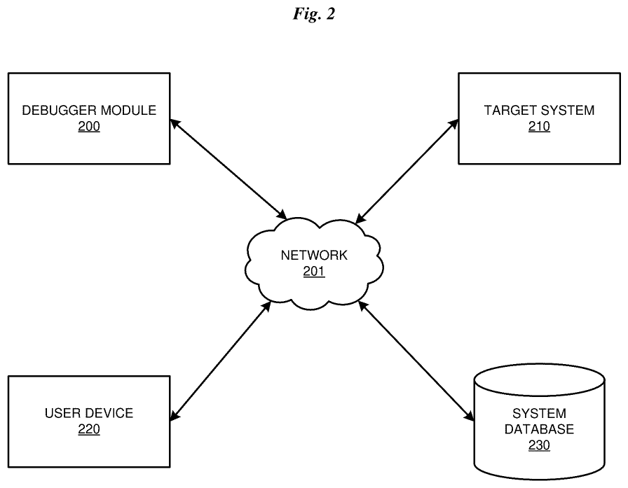

FIG. 2 depicts a block diagram of an example computing environment in accordance with an illustrative embodiment. In the illustrated embodiment, the debugger module 200 includes the debugger module 200 of FIG. 1. In the illustrative embodiment, the debugger module 200 is configured to compute Shapley explanations and generate prompting recommendations to guide a large language model (LLM) to generate user desired outcomes.

In an embodiment, the debugger module 200 is configured to perform a method for computing local model-agnostic Shapley explanations. Embodiments of the method provide a way to calculate attribution scores on a per-example basis for each prediction made by a machine learning model. In an embodiment, the process includes determining the contribution of each feature to the prediction outcome for a specific data point. By leveraging the Shapley value concept, the method assigns a unique attribution score to each feature based on its impact on the prediction.

The local model-agnostic aspect of the method provides that the explanation is not tied to a specific model architecture or training data. This means that the attribution scores are calculated independently of the underlying machine learning model, making the explanations applicable across different models and datasets. Further, by providing per-example attribution scores, the method offers transparency and interpretability into how individual features influence the model's predictions for each data point. This granular level of explanation can aid in understanding the model's decision-making process and identifying the relevant factors driving specific predictions.

An embodiment prompts a large language model associated with target system 210 with a set of in-context examples stored on system database 230. The debugger module 200 receives the prompting results from target system 210 and generates an attribution score for each in-context example of the set of in-context examples based on the prompting results. The debugger module 200 generates a prompting recommendation based on the attribution score for each in-context example of the set of in-context examples. The debugger module prompts the language model using the prompting recommendation.

In an embodiment, a user accessing user device 220 prompts a large language model executed as a part of target system 210 with a curated set of in-context examples tailored to the specific task or context. These in-context examples are designed to provide targeted guidance and relevant information to the model, influencing its text generation process towards producing accurate and contextually appropriate outputs. In an embodiment, following the prompt with the set of in-context examples, the model generates an output. In an embodiment, the debugger module 200 receives the output from the target system 210 and generates an attribution score for each individual in-context example within the set. The attribution score quantifies the impact and contribution of each example towards the model's predictions, providing insight on the significance of each example in influencing the model's decision-making and/or prediction process.

Based on the attribution scores calculated for each in-context example, the debugger module 200 formulates prompting recommendations. These recommendations are derived from the attribution scores and indicate the relative importance or relevance of each in-context example in guiding the model's text generation. By leveraging the attribution scores, the debugger module 200 can prioritize and highlight the most influential examples for the model to consider during the text generation process. In an embodiment, the debugger module 200 generates an example ranking, the example ranking reflecting the relative influence of each example-pair on the output of the large language model.

In an embodiment, the debugger module 200 utilizes the prompting recommendations to prompt the large language model. By incorporating the prompting recommendations derived from the attribution scores, the debugger module 200 guides the model towards focusing on the most impactful and informative in-context examples. This iterative process enhances the model's ability to generate text that aligns closely with the task objectives and context, leading to improved accuracy and relevance in the generated outputs.

In the illustrated embodiment, the system database 230 includes a repository for all data related to target system 210. In an embodiment, the system database 230 stores one or more sets of example-pairs that may be leveraged by a machine learning model to generate an output. In an embodiment, the system database 230 stores one or more sets of prompting instructions. In an embodiment, the system 230 stores one or more sets of test cases for evaluating utility and/or performance of an output. In an embodiment, the system database 230 stores one or more sets of training data for training one or more machine learning models.

In the illustrated embodiment, user device 220 includes a computing device configured to facilitate user interaction with the debugger module 200, thereby enabling a user to engage with the management of various operations related to target system 210. Accordingly, user device 220 may serve as an interface through which users can communicate instructions, commands, or requests to the debugger module 200, initiating related actions and overseeing the target system's performance. Through user device 220, a user can access a user interface or application that allows the user to interact with the debugger module 200. Users may input commands, configure settings, and monitor system performance through the interface provided by user device 220.

In an embodiment, user device 220 may support various communication channels, such as a graphical user interface (GUI), a command-line interface (CLI), a web-based portal, or a mobile application, depending on the system's design and user requirements. Users can communicate with the debugger module 200 in real-time to view visualizations related to operations disclosed herein.

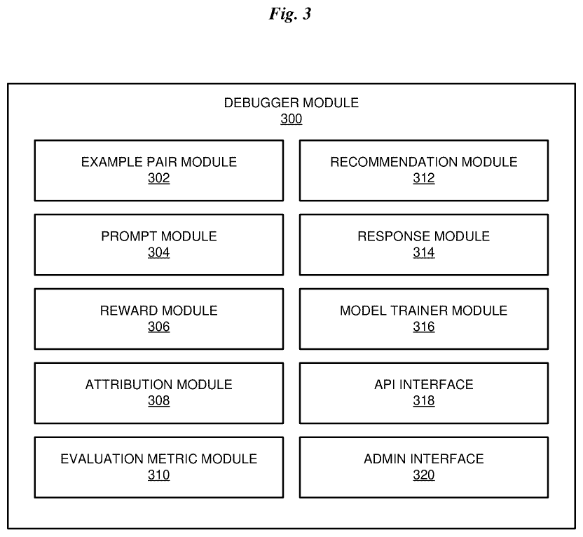

FIG. 3 depicts a block diagram of an example debugger software module 300 in accordance with an illustrative embodiment. In the illustrated embodiment, debugger module 300 is an example of debugger module 200 of FIGS. 1 and 2.

In the illustrated embodiment, the debugger module 300 includes a software module including a plurality of other software modules, including an example pair module 302, a prompt module 304, a reward module 306, an attribution module 308, an evaluation metric module 310, a recommendation module 312, a response module 314, a model trainer module 316, an API interface module 318, and an administrator interface module 320. In alternative embodiments, debugger module 300 can include some or all of the functionality described herein but grouped differently into one or more modules. In some embodiments, the functionality described herein is distributed among a plurality of systems, which can include combinations of software and/or hardware-based systems, for example Application-Specific Integrated Circuits (ASICs), computer programs, or smart phone applications.

In some embodiments, the debugger module 300 comprises a physical computing device, including but not limited to, a general-purpose computer, a mainframe computer, a supercomputer, a quantum computer, a computer server, a personal computer, a laptop, a smartphone, a tablet, a personal digital assistant (PDA), etc., and any combination thereof. In some embodiments, the debugger module 300 comprises specialized hardware, such as for example, an Application-Specific Integrated Circuit (ASIC) or Field-Programmable Gate Array (FPGA) for accelerated processing of specific tasks, routines, algorithms, training operations, etc. In some embodiments, the debugger module 300 may include a combination of physical and virtualized components, as well as may be partially or entirely virtualized on a virtual machine.

In the illustrated embodiment, the example pair module 302 includes a software module configured to store a set of example pairs for inputting into a large language model. In an embodiment, the example pair module 302 includes a database for storing example pairs. In an embodiment, the database organizes example pairs based on relevance to a particular task or tasks. In an embodiment, the example-pair module 302 stores example-pairs related to various tasks such as text summarization, code translation, sentiment analysis, question-answering, named entity recognition, image captioning, document classification, and speech recognition, and various other task described herein. For example, for text summarization tasks, example pairs may include original text paragraphs and corresponding summarized text. For code translation tasks, pairs may include source language text and target language translations. For sentiment analysis tasks, example-pairs may include text reviews and sentiment labels. For question-answering tasks, example-pairs may include questions and answers. For named entity recognition tasks, example-pairs may include text sentences and identified named entities. For image captioning tasks, example-pairs may include images and descriptive captions. For document classification tasks, example-pairs include document text and category labels. For speech recognition tasks, example-pairs may include audio clips and transcribed text.

In the illustrated embodiment, the prompt module 304 includes a software module configured to generate and construct a prompt for inputting into a large language model. In an embodiment, the prompt module 304 receives a set of example pairs from the example pair module 302 and constructs coalitions or combinations of example pairs. In an embodiment, prompt module 304 constructs example pair coalitions based on the context of a particular task. In an embodiment, the prompt module 304 generates a prompt for each possible combination and permutation of available examples pairs for a given task.

In an embodiment, the prompt module 304 concatenates an input string with example pairs, instructions, and any other relevant elements or artifacts that provide context and guidance to the model. The prompt module 304 integrates the input string, which may contain initial context or a specific task description, with the example pairs retrieved from the example pair module 302. These example pairs, representing various scenarios or data points relevant to the task, are concatenated with the input string to provide specific cues and information to the model. Additionally, the prompt module 304 may incorporate instructions or guidelines that direct the model on how to interpret and utilize the example pairs within the prompt. Further, the prompt module 304 may include other relevant elements or artifacts, such as metadata, formatting cues, or special tokens, to enhance the prompt's effectiveness in guiding the model's text generation.

In the illustrated embodiment, the reward module 306 includes a software module configured to compute a reward for each output produced as a result of inputting each prompt into a large language model. In an embodiment, the output is based on an evaluation metric defined by evaluation metric module 310. In an embodiment, the evaluation metric includes a number of errors associated with the output. Accordingly, the number of errors may indicate the performance of a prompt relative to the errors or lack thereof caused by the output of the prompt. In an embodiment, the reward module 306 generates a set of reward values based on the performance of each combination of example pairs against a predefined performance evaluation metric.

In the illustrated embodiment, the attribution module 308 includes a software module configured to compute an attribution score for each example pair based on the reward values computed corresponding to the combinations of example pairs evaluated. In an embodiment, the attribution module employs a Shapley explanation technique to compute an attribution score for each example pair of the set of example pairs.

Suppose a scenario where the reward for a specific combination or coalition of example pairs is determined to be 8 out of 10. In this scenario, the attribution module 308 assesses the individual contributions of each example pair towards achieving the overall reward value of 8. By delving into the attribution analysis, the module determines the extent to which each example pair is responsible for the collective 8 out of 10 value metric. For example, in the above example, the attribution module may determine that a first example-pair provides +6, a second example-pair provides +4, and a third example-pair provides −2. Further, in the above scenario, a recommendation may include removing the third example-pair to improve the reward by way of forming an optimal coalition of example pairs based on Shapley explanations. The Shapley explanation algorithm, when applied to computing attribution scores for individual features, such as example-pairs in this scenario, follows a systematic process to determine the contribution of each feature to the overall outcome.

In the context of example-pairs as features, the attribution module 308 employs an algorithm that quantifies the impact of each pair on the model's predictions and decision-making process. In an embodiment, the algorithm begins by considering all possible permutations of example-pairs and evaluating the marginal contribution of each pair to the model's performance. An embodiment systematically analyzes the interactions between different example-pairs and their influence on the model's output. By comparing the model's predictions with and without the inclusion of a specific example-pair, the algorithm determines the difference in the output attributed to that pair. Through this iterative process, the Shapley explanation algorithm calculates the attribution score for each example-pair based on its average marginal contribution across all permutations.

The algorithm provides that each pair is assigned a fair and interpretable attribution score that reflects its unique impact on the model's predictions. By leveraging the principles of cooperative game theory and fairness, the Shapley explanation algorithm provides a transparent and principled approach to computing attribution scores for individual features, such as example-pairs. The algorithm offers insights into the relative importance and influence of each pair on the model's decision-making process, enhancing the interpretability and understanding of the model's behavior, as well as providing for optimized prompting recommendations that provide the best outcome per example-pair combination.

In the illustrated embodiment, the evaluation metric module 310 includes a software module configured to define one or more evaluation metrics. Examples of evaluation metrics may include, but are not limited to, BLEU score, ROUGE score, perplexity, accuracy, precision, recall, F1 score, codeBERTScore, edit distance, and semantic similarity metrics. These evaluation metrics serve as quantitative measures to evaluate the model's generation capabilities and its alignment with the desired task objectives.

For example, the BLEU score may be used in natural language processing tasks to measure the similarity between the model's generated text and the reference text based on n-gram overlap. The ROUGE score may be used to evaluate the quality of text summaries by comparing the overlap of n-grams between the generated summary and the reference summary. Precision, recall, and F1 score are metrics that may be used in classification tasks to assess the model's performance in correctly identifying positive and negative instances. CodeBERTScore may be used in code generation tasks to evaluate the similarity between the generated code and the ground-truth code based on code-specific features and structures. Edit distance may be used to measures the number of operations required to transform one sequence into another, providing insights into the similarity between sequences. Semantic similarity metrics may be used to assess the semantic relatedness between text inputs and outputs.

Further, the evaluation metric module 310 may be configured to define one or more thresholds. In an embodiment, the evaluation metric module 310 defines a performance threshold, such as a minimum evaluation metric score, or a maximum error rate, to establish the desired level of accuracy and quality for the model's outputs. The evaluation metric module 310 may be used to define any number or type of thresholds to determine the model's performance against these metrics. By defining thresholds, the module enables the system to assess whether the model meets the predefined performance criteria and to take appropriate actions based on the evaluation results.

In the illustrated embodiment, the recommendation module 312 includes a software module configured to generate a recommendation based on insights generated by the debugger module 300. For example, the recommendation module 312 may be configured to generate a recommendation to construct an optimal set of example pairs based on the attribution score of each example pair. In an embodiment, the recommendation module 312 is configured to recommend a set of example-pairs that collectively offer the greatest relative reward compared to other combinations of example-pairs. This recommendation process aims to guide the selection of example-pairs that are most effective in influencing the model's generation process and optimizing its performance, said combination of example-pairs are herein considered an optimal set of example-pairs. For example, in the above example scenario, the attribution module 308 may determine that a first example-pair provides +6, a second example-pair provides +4, and a third example-pair provides −2. In such scenario, the recommendation module 312 may determine that a combination of the first example-pair and the second example-pair constitutes an optimal set of example-pairs, and may proceed to recommend the optimal set of example-pairs for prompting.

In the illustrated embodiment, the response module 314 includes a software module configured to execute a responsive action based on a recommendation received from the recommendation module 312. For example, upon receiving a recommendation to construct an optimal set of example pairs, the response module 314 may cause the prompt module 304 to construct a prompt such that the prompt includes the optimal set of examples recommended by the recommendation module 312.

In the illustrated embodiment, the model trainer module 316 includes a software module configured to train one or more machine learning models described herein. In an embodiment, model training module 316 includes a data preparation module, an algorithm module, a training engine, and a machine learning model. In alternative embodiments, model training module 316 can include some or all of the functionality described herein but grouped differently into one or more modules. In some embodiments, model trainer module 316 generates a machine learning model based on one or more known machine learning algorithms. In an embodiment, model trainer module 316 includes a training engine that trains machine learning model using training a dataset.

In the illustrated embodiment, the model trainer module 316 is configured to train a large language model using curated set of example-pairs, prompts, and recommendations generated by the system and/or from external sources. In an embodiment, the training process includes fine-tuning, transfer learning, and/or reinforcement learning, to enhance the model's performance and accuracy. Through iterative training iterations, the module refines the model's generation abilities, fine-tunes its parameters, and adjusts its behavior based on the feedback received during the training process. In an embodiment, model trainer module 316 continuously evaluates the model's performance against predefined evaluation metrics and thresholds to monitor training progress and ensure that trained model meets the desired standards of accuracy and quality. By analyzing the model's outputs and comparing them against the defined metrics, the model trainer module 316 iteratively refines the model's training process to optimize generation performance.

In the illustrated embodiment, the API interface module 318 serves as the interface through which users and/or applications interact with the debugger and/or agents orchestrated by the debugger module 300 and facilitates the exchange of information between the users and/or applications and these modules. In an embodiment, the application interface module 318 is configured to interact with any or all other modules within debugger module 300 to retrieve, transmit, store, and/or modify information and/or execute functions and operations as described herein. In some embodiments, API interface module 318 connects with API gateway via any suitable network or combination of networks such as the Internet, etc. and uses any suitable communication protocols such as Wi-Fi, Bluetooth, etc. to connect to external systems required to access to perform certain tasks. Further, the API gateway may transmit service requests received from a client interacting with debugger module 300.

In the illustrated embodiment, administrative module 320 allows users with administrative privileges to perform various administrative tasks associated with debugger module 300 as described herein. For example, in some embodiments, administrative user module 320 allows a user with administrative privileges to initiate a data collection process. As another example, in some embodiments, administrative module 320 allows a user with administrative privileges to initiate and monitor the training process performed by model training module 316, including setting desired parameters and/or hyperparameters for the training process.

In an embodiment, administrative module 320 includes a user interface configured to allow a user having sufficient privileges to oversee the operation and management of a large language model-based system. In an embodiment, administrator module 320 controls access permissions, monitors system performance, and handles any administrative tasks related to the platform. In an embodiment, the administrator module 320 interacts with any or all other modules to promote compliance with the administrative settings. Further, a backend administration system allows users with administrative privileges to perform various administrative tasks associated with the module as described herein, such as initiating a data collection and/or correlation process, a neural network training process, defining optimization goals, defining execution parameters/criteria, and any other defined settings discussed herein.

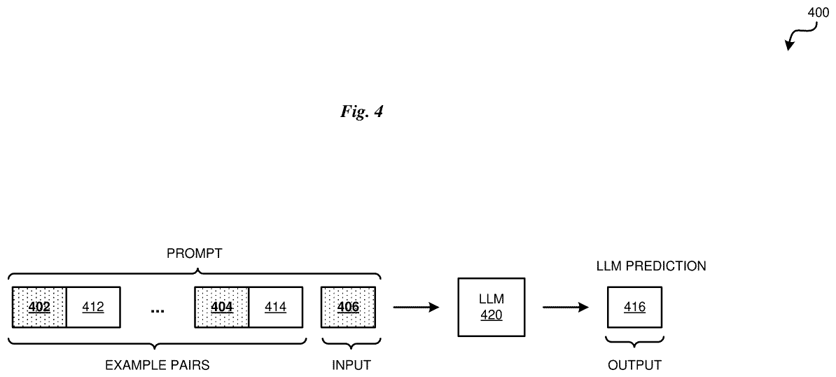

FIG. 4 depicts a block diagram of an example process for prompting a large language model. In the illustrated embodiment, process 400 includes prompting a large language model (LLM) using a set of in-context example pairs. For example, in the illustrated embodiment, the set of in-context example pairs includes a first example pair comprising a first example input 402 and a first example output 412 and a second example pair comprising a second example input 404 and a second example output 414, which are shown accompanying the input 406 to the LLM 420.

In the illustrated embodiment, inputting the LLM 420 with the prompt causes the LLM 420 to output a prediction 416 based on the prompt. Accordingly, the inclusion of the first example pair and the second example pair with the input 406 to the LLM 420 influences the LLM 420 to generate an output 416 that is influenced by the first example pair and the second example pair. By inputting the LLM 420 with the prompt, the system triggers the model to analyze and interpret the provided information, leading to the generation of a prediction 416 that aligns with the context and cues presented in the prompt.

In the illustrated embodiment, the inclusion of the first example pair and the second example pair along with the input 406 to the LLM 420 shapes the model's output. These example pairs may provide specific instances or scenarios that offer additional context and guidance to the model. By incorporating the first example pair and the second example pair into the input 406, the LLM 420 is influenced to consider the content and patterns presented in these pairs during the text generation process. Accordingly, the presence of the first example pair and the second example pair combined with the input 406 influences the LLM 420 to generate an output 416 that reflects the characteristics and information contained in these example pairs. The model integrates the insights and context provided by the example pairs into its decision-making process, resulting in an output that is influenced by the content, structure, and/or patterns observed in the first example pair and the second example pair.

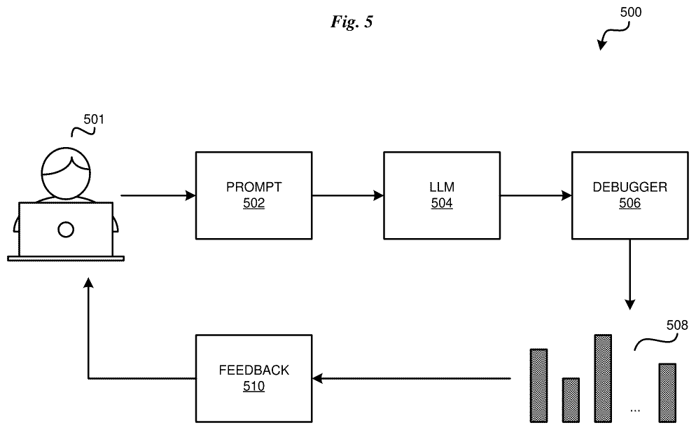

FIG. 5 depicts a block diagram of an example process for debugging a large language model prompting process. In the illustrated embodiment, aspects of the depicted process 500 may be executed in whole or in part by debugger module 200 of FIGS. 1 and 2 and/or debugger module 300 of FIG. 3.

In the illustrated embodiment, a user 501 is shown generating a prompt 502. In an embodiment, the prompt 502 may include a set of in-context examples that are included with a particular input to guide the output of the large language model (LLM) 504. In an embodiment, the prompt 502 may include a set of instructions to guide the output of the LLM 504.

In the illustrated embodiment, the LLM 504 receives the prompt 502 transmitted from the user 501 and generates an output. In the illustrated embodiment, the output of the LLM 504 is transmitted to the debugger module 506 for processing. In the illustrated embodiment, the debugger module 506 processes the output execution results into a set of attribution scores such that each attribution score corresponds to an artefact of the prompt 502 transmitted to the LLM 504. In an embodiment, the artefact includes an example pair, an instruction, or any other feature related to a prompt 502. In an embodiment, the debugger module 506 computes Shapley explanations for each combination of features contained within the prompt 502.

In the illustrated embodiment, the process includes generating feedback 510 based on the set of attribution scores 508 computed by the debugger module 506. In an embodiment, the debugger module 506 generates one or more recommendations for prompting the LLM 504. In an embodiment, the recommendation may include constructing a particular combination of artefacts, based on the attribution scores. In an embodiment, the recommendation may include prompting the LLM 504 with an optimal combination of example-pairs. In an embodiment, the recommendation may include prompting the LLM 504 with an optimal set of prompting instructions. In the illustrated embodiment, the feedback 510 is transmitted to the user 501 for additional interaction with the LLM 504.

In an embodiment, the recommendations provided by the debugger module 506 in the feedback 510 may include suggestions to include or omit particular elements or artifacts from the prompt 502. For example, if certain example pairs are identified as highly influential based on their attribution scores, the debugger module 506 may recommend including these specific pairs in the prompt to guide the model effectively. These influential example pairs can provide context and cues to enhance the model's understanding and improve the quality of the generated outputs. Conversely, if certain elements or artifacts are found to have a minimal, negative, or otherwise undesirable impact on the model's predictions based on their attribution scores, the debugger module 506 may recommend omitting these elements from the prompt. By excluding less influential elements, the prompt can become focused on the most relevant and impactful information, optimizing the model's decision-making process and improving the coherence and accuracy of the generated output.

In an embodiment, the feedback 510 may include computer generated graphical visualizations of elements based on their attribution scores generated by the debugger module 506. These visual representations provide a graphical means to convey the influence and impact of different elements, such as example pairs, instructions, or artifacts, on the model's generation process. By presenting graphical visualizations, stakeholders can easily interpret and understand the relative importance of each element in guiding the model's decision-making. In some embodiments, the graphical visualizations included in the feedback 510 may take the form of bar charts, pie charts, heatmaps, or scatter plots, among other types of visual representations. Bar charts can display the attribution scores of different elements side by side, allowing for easy comparison of their relative impacts. Pie charts can illustrate the distribution of attribution scores across various elements, highlighting the proportion of influence each element holds. Heatmaps can provide a visual representation of the strength of influence of elements based on color gradients, with darker shades indicating higher attribution scores. Scatter plots can show the relationship between elements and their attribution scores, revealing patterns and correlations in the data.

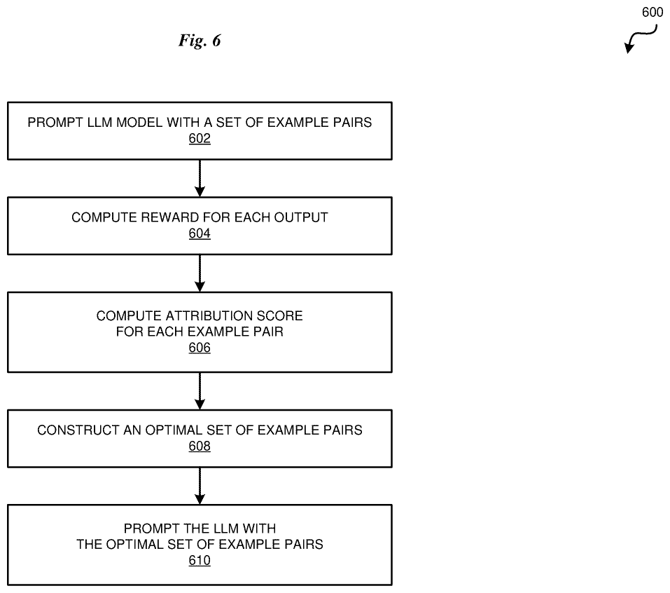

FIG. 6 depicts a flowchart of an example process for prompt debugging in accordance with an illustrative embodiment. In an embodiment, debugger module 200 of FIGS. 1 and 2, debugger module 300 of FIG. 3 carries out some or all of the steps of process 600.

In an embodiment, at step 602, the process includes prompting a large language model (LLM) with a set of example pairs. Each example pair includes input-output instances that are specifically paired together to provide contextual relevance and generation guidance to the LLM. By presenting the model with these paired examples, the process provides targeted cues and information that can influence the model's generation process towards producing more accurate and contextually appropriate outputs. Accordingly, the pairing of examples helps the LLM understand the relationships and connections between different inputs-output, enhancing the model's ability to generate coherent and relevant outputs based on the provided task context.

In an embodiment, at step 604, the process includes computing a reward for each output corresponding to each combination of example pairs. In an embodiment, the process computes a reward for each output of the LLM based on the distance between the model's prediction and the ground-truth reference. This distance metric can be calculated using various evaluation methods, which may include but are not limited to, BLEU (Bilingual Evaluation Understudy), CodeBERTScore, edit distance, or other similarity metrics that compare the generated output with the expected or correct reference output.

For example, BLEU score is a metric in natural language processing tasks that measures the similarity between the model's generated text and the reference text based on n-gram overlap. A higher BLEU score indicates a closer match between the model's output and the ground-truth reference, leading to a higher reward for the model's performance. As another example, CodeBERTScore can be employed in code generation tasks to evaluate the similarity between the generated code and the ground-truth code based on code-specific features and structures. This metric provides a quantitative measure of the model's accuracy in generating code outputs that align with the expected coding standards and functionalities.

Further, in addition to similarity metrics, the system may also compute rewards based on error scores between the original input and the translated output. This approach may include comparing the model's generated output with the ground-truth translation or expected output, assessing the accuracy and correctness of the model's predictions. Further, the process may include additional evaluation criteria such as test cases, syntax analysis, or semantic evaluation to assess the quality and correctness of the model's outputs. By considering various error analysis techniques and evaluation methods, the provides a comprehensive assessment of the model's performance and generate rewards that reflect the model's ability to produce accurate and contextually relevant outputs. Accordingly, by computing rewards based on distance metrics, error scores, and additional evaluation criteria, the process can effectively evaluate the performance of the LLM in generating outputs that closely match the ground-truth references or expected outputs.

In an embodiment, at step 606, the process includes computing an attribution score for each example pair of the set of example pairs based on the reward for each output corresponding to each combination of example pairs. The attribution score quantifies the contribution and impact of each example pair towards the model's generation process. By analyzing the rewards associated with the outputs generated from each example pair, the process computes attribution scores that reflect the importance and relevance of each pair in influencing the model's decision-making and output quality. These attribution scores provide insights into the effectiveness of each example pair in guiding the model's generation and helps prioritize the most influential pairs for the model to consider during the generation process.

In an embodiment, the process models the LLM prediction with in-context examples as a coalition game, where the reward function computed for the LLM prediction serves as the utility function of the game. In this context, the coalition game framework represents the interaction between the in-context examples and the LLM prediction, with the goal of determining the contribution or impact of each example subset (coalition) towards the model's output quality.

In an embodiment, each coalition of in-context examples is considered a player in the coalition game, and the reward function quantifies the value or payoff associated with the coalition's performance in influencing the LLM prediction. By treating the prediction process as a coalition game, the system can analyze the collaborative effects of different example subsets on the model's output and evaluate their collective impact on the prediction quality. To determine the attribution scores for each example within the coalition game framework, the system computes the Shapley value for each example based on the approach proposed by Lloyd Shapley. The Shapley value assigns a fair and unique attribution score to each player (example) in a coalition game, reflecting their marginal contribution to the overall payoff of the coalition.

In an embodiment, to compute Shapley values, the process generates outputs for all possible subsets of the in-context examples (2\textcircled{ }K combinations for K examples) and measures how each combination affects the reward. In an embodiment, this aspect of process may involve batching, where all combinations are evaluated in a single LLM call. In an embodiment, this aspect of process may involve quantization by optionally using quantized versions of the LLM (e.g., 4-bit or 8-bit) to reduce computation cost. By calculating the Shapley value for each example based on the Lloyd Shapley solution, the system can derive per-example attribution scores that indicate the individual importance and influence of each example in contributing to the LLM prediction. These attribution scores provide insights into the relative impact of each example subset on the model's decision-making process and output quality, helping to identify the most influential examples and prioritize them in guiding the model's text generation. Accordingly, by modeling the LLM prediction process as a coalition game and computing the Shapley values for each example subset, the process can generate per-example attribution scores for the in-context examples.

Further, the per-example attribution scores derived from the model's prediction process can serve as insights for users or agents in debugging prompts used to guide the LLM. These attribution scores provide users or agents with a detailed understanding of the impact and influence of individual in-context examples on the model's generation, offering a transparent view of how each example contributes to the model's decision-making process. For example, users can analyze the per-example attribution scores to identify which in-context examples have the most significant impact on the LLM's predictions. By focusing on examples with high attribution scores, users can pinpoint influential examples that strongly influence the model's output. Debugging prompts can involve assessing the content and relevance of these influential examples to their alignment with the intended task objectives.

Further, users can use the attribution scores to evaluate the effectiveness of the prompts in guiding the LLM's generation process. By examining how different examples contribute to the model's predictions, users can assess whether the prompts provide relevant context, cues, and information to steer the model towards generating accurate and contextually appropriate outputs. Debugging prompts may involve adjusting or refining the prompt examples based on the attribution scores to improve the model's performance. Even further, users can validate the consistency and coherence of the prompts by comparing the attribution scores across different examples. Discrepancies or inconsistencies in the attribution scores may indicate variations in the relevance or impact of different examples on the model's predictions. Even further, users can refine the selection of in-context examples included in the prompts based on the per-example attribution scores. By prioritizing examples with higher attribution scores and relevance to the task, users can optimize the prompt set to guide the LLM more effectively towards generating desired outputs. Debugging prompts may involve iteratively adjusting the prompt examples based on the attribution scores to enhance the model's performance.

In an embodiment, at step 608, the process includes constructing an optimal set of example pairs based on the attribution score for each example pair of the set of example pairs. By leveraging the attribution scores, the process can prioritize and identify example pairs that have the highest impact on the LLM's predictions. The high-scoring example pairs are considered more effective in guiding the model towards generating accurate and contextually appropriate outputs than low-scoring example-pairs, or even negative value example-pairs. Constructing an optimal set of example pairs involves selecting a subset of example pairs that collectively offer the most significant reward and influence on the model's decision-making process.

In an embodiment, at step 610, the process includes prompting the large language model (LLM) with the optimal set of example pairs. By prompting the LLM with the optimal set of example pairs, the process causes the model to receive targeted and influential guidance that aligns with the task objectives and context. Prompting the LLM with the optimal set of example pairs aims leverages the collective impact of high-scoring examples to improve the accuracy, relevance, and coherence of the model's generation. By providing the model with examples that have demonstrated significant influence in the attribution scores, the process enhances the model's ability to generate outputs that are aligned with the intended task requirements and context.

The embodiments disclosed herein may be extended beyond in-context examples. Accordingly, embodiments disclosed herein may consider obtaining attribution scores of instructions or other artifacts within a prompt beyond in-context examples. In an embodiment, the attribution scoring mechanism may be adapted to consider the impact and influence of these additional elements on the LLM's generation process. In some embodiments, the process may include defining the instructions or artifacts within the prompt that are intended to guide the LLM's generation. These elements could encompass specific directives, guidelines, constraints, or any contextual information provided to the model to influence its output. The impact of instructions or artifacts on the LLM's predictions may be similarly analyzed to assess how these elements influence the generated output in terms of coherence, relevance, and accuracy of the model's outputs in response to the instructions provided.

The attribution values of other elements similarly reflect the importance and effectiveness of these elements in guiding the LLM towards producing contextually appropriate and accurate outputs. For example, by calculating these scores, the system can prioritize instructions with higher attribution scores to ensure that the model receives effective guidance during the generation process. Embodiments further consider extending the prompting recommendations to include guidance on how instructions or artifacts within the prompt should be utilized can optimize prompt construction. In some embodiments, the process combines higher impact examples with influential instructions to provide comprehensive and targeted guidance to the LLM.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
intercepting a user input prompt sent to a large language model;
extracting a set of prompt features from the user input prompt, the set of prompt features comprising a set of context examples;
constructing a set of test prompts using the set of context examples, wherein each test prompt of the set of test prompts comprises a different combination of context examples;
executing the set of test prompts by the large language model, the executing producing a set of execution results;
causing, responsive to executing the set of test prompts, an execution of a first specific instruction to execute an attribution scoring algorithm to compute an attribution score for each context example, the executing the attribution scoring algorithm producing a set of attribution scores, wherein each attribution score reflects a marginal contribution of a corresponding context example in producing the set of execution results;
causing, responsive to producing the set of attribution scores, an execution of a second specific instruction to manipulate the user input prompt, the manipulating comprising replacing a portion of the user input prompt to include a candidate set of context examples, the candidate set of context examples comprising a subset of the context examples identified as providing a greatest combined performance metric based on the set of attribution scores, the manipulating producing a modified prompt input;
causing, responsive to producing the modified prompt input, an execution of a fourth specific instruction that submits the modified prompt input to the large language model.

2. The computer-implemented method of claim 1, wherein the set of prompt features further comprises a set of prompting instructions, and wherein the method further comprises:
constructing a second set of test prompts using the set of prompting instructions, wherein each test prompt of the second set of test prompts comprises a different combination of prompting instructions;
executing the second set of test prompts by the large language model, the executing producing a second set of execution results;
causing, responsive to executing the second set of test prompts, an execution of a fourth specific instruction to execute an attribution scoring algorithm to compute an attribution score for each prompting instruction, the executing the attribution scoring algorithm producing a second set of attribution scores, wherein each attribution of the second set of attribution scores reflects a marginal contribution of a corresponding prompting instruction in producing the set of execution results;
causing, responsive to producing the second set of attribution scores, an execution of a fifth specific instruction to manipulate the user input prompt, the manipulating comprising replacing a portion of the user input prompt to include a candidate set of prompting instructions, the candidate set of prompting instructions comprising a subset of the prompting instructions identified as providing a greatest combined performance metric based on the second set of attribution scores, the manipulating producing a second modified prompt input;
causing, responsive to producing the second modified prompt input, an execution of a sixth specific instruction that submits the second modified prompt input to the large language model.

3. The computer-implemented method of claim 1, wherein the performance metric corresponds to accuracy of translating between texts in a machine language translation process.

4. The computer-implemented method of claim 1, wherein the performance metric corresponds to a number of successful test case executions in a machine code translation process.

5. The computer-implemented method of claim 1, the method further comprising:
generating a graphical representation of the attribution score corresponding to each context example; and
displaying the graphical representation on a user interface.

6. The computer-implemented method of claim 1, the method further comprising:
causing, responsive to producing the modified prompt input, an execution of a seventh specific instruction to generate a prompting recommendation based on the set of attribution scores, wherein the prompting recommendation comprises a natural language explanation of the candidate set of context examples;
causing, responsive generating the prompting recommendation, an execution of an eighth specific instruction that submits the prompting recommendation to the large language model.

7. The computer-implemented method of claim 1, wherein executing the set of test prompts further comprises executing a portion of the set of test prompts on a second large language model.

8. The computer-implemented method of claim 1, wherein the second large language model comprises a quantized version of the large language model.

9. A computer program product comprising one or more computer readable storage media, and program instructions collectively stored on the one or more computer readable storage media, the program instructions executable by a processor to cause the processor to perform operations comprising:
intercepting a user input prompt sent to a large language model;
extracting a set of prompt features from the user input prompt, the set of prompt features comprising a set of context examples;
constructing a set of test prompts using the set of context examples, wherein each test prompt of the set of test prompts comprises a different combination of context examples;
executing the set of test prompts by the large language model, the executing producing a set of execution results;
causing, responsive to executing the set of test prompts, an execution of a first specific instruction to execute an attribution scoring algorithm to compute an attribution score for each context example, the executing the attribution scoring algorithm producing a set of attribution scores, wherein each attribution score reflects a marginal contribution of a corresponding context example in producing the set of execution results;
causing, responsive to producing the set of attribution scores, an execution of a second specific instruction to manipulate the user input prompt, the manipulating comprising replacing a portion of the user input prompt to include a candidate set of context examples, the candidate set of context examples comprising a subset of the context examples identified as providing a greatest combined performance metric based on the set of attribution scores, the manipulating producing a modified prompt input;
causing, responsive to producing the modified prompt input, an execution of a fourth specific instruction that submits the modified prompt input to the large language model.

10. The computer program product of claim 9, wherein the stored program instructions are stored in a computer readable storage device in a data processing system, and wherein the stored program instructions are transferred over a network from a remote data processing system.

11. The computer program product of claim 9, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

12. The computer program product of claim 9, wherein the set of prompt features further comprises a set of prompting instructions, and wherein the operations further comprises:
constructing a second set of test prompts using the set of prompting instructions, wherein each test prompt of the second set of test prompts comprises a different combination of prompting instructions;
executing the second set of test prompts by the large language model, the executing producing a second set of execution results;
causing, responsive to executing the second set of test prompts, an execution of a fourth specific instruction to execute an attribution scoring algorithm to compute an attribution score for each prompting instruction, the executing the attribution scoring algorithm producing a second set of attribution scores, wherein each attribution of the second set of attribution scores reflects a marginal contribution of a corresponding prompting instruction in producing the set of execution results;
causing, responsive to producing the second set of attribution scores, an execution of a fifth specific instruction to manipulate the user input prompt, the manipulating comprising replacing a portion of the user input prompt to include a candidate set of prompting instructions, the candidate set of prompting instructions comprising a subset of the prompting instructions identified as providing a greatest combined performance metric based on the second set of attribution scores, the manipulating producing a second modified prompt input;
causing, responsive to producing the second modified prompt input, an execution of a sixth specific instruction that submits the second modified prompt input to the large language model.

13. The computer program product of claim 9, wherein the performance metric corresponds to accuracy of translating between texts in a machine language translation process.

14. The computer program product of claim 9, wherein the performance metric corresponds to a number of successful test case executions in a machine code translation process.

15. The computer program product of claim 9, further comprising:
generating a graphical representation of the attribution score corresponding to each context example; and
displaying the graphical representation on a user interface.

16. The computer program product of claim 9, further comprising:
causing, responsive to producing the modified prompt input, an execution of a seventh specific instruction to generate a prompting recommendation based on the set of attribution scores, wherein the prompting recommendation comprises a natural language explanation of the candidate set of context examples;
causing, responsive generating the prompting recommendation, an execution of an eighth specific instruction that submits the prompting recommendation to the large language model.

17. The computer program product of claim 9, wherein executing the set of test prompts further comprises executing a portion of the set of test prompts on a second large language model.

18. The computer program product of claim 9, wherein the second large language model comprises a quantized version of the large language model.

19. A computer system comprising a processor and one or more computer readable storage media, and program instructions collectively stored on the one or more computer readable storage media, the program instructions executable by the processor to cause the processor to perform operations comprising:
intercepting a user input prompt sent to a large language model;
extracting a set of prompt features from the user input prompt, the set of prompt features comprising a set of context examples;
constructing a set of test prompts using the set of context examples, wherein each test prompt of the set of test prompts comprises a different combination of context examples;
executing the set of test prompts by the large language model, the executing producing a set of execution results;
causing, responsive to executing the set of test prompts, an execution of a first specific instruction to execute an attribution scoring algorithm to compute an attribution score for each context example, the executing the attribution scoring algorithm producing a set of attribution scores, wherein each attribution score reflects a marginal contribution of a corresponding context example in producing the set of execution results;
causing, responsive to producing the set of attribution scores, an execution of a second specific instruction to manipulate the user input prompt, the manipulating comprising replacing a portion of the user input prompt to include a candidate set of context examples, the candidate set of context examples comprising a subset of the context examples identified as providing a greatest combined performance metric based on the set of attribution scores, the manipulating producing a modified prompt input;
causing, responsive to producing the modified prompt input, an execution of a fourth specific instruction that submits the modified prompt input to the large language model.

20. The computer system of claim 19, further comprising:
causing, responsive to producing the modified prompt input, an execution of a seventh specific instruction to generate a prompting recommendation based on the set of attribution scores, wherein the prompting recommendation comprises a natural language explanation of the candidate set of context examples;
causing, responsive generating the prompting recommendation, an execution of an eighth specific instruction that submits the prompting recommendation to the large language model.
